(19) United States
(12) Patent Application Publication
(10) Pub. No.: US 2006/0137164 A1
(43) Pub. Date: Jun. 29, 2006

(54) Method and device for mounting several add-on parts on production part

(75) Inventor: Helmut Kraus, Hildrizhausen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Sttuttgart (DE)

(21) Appl. No.: 10/527,977

(22) PCT Filed: Sep. 6, 2003
(86) PCT No.: PCT/EP03/09915

§ 371 Date: Oct. 20, 2005

(30) Foreign Application Priority Data
Sep. 13, 2002 (DE) 102 42 710.0

(51) Int. Cl. B23Q 17/00

(52) U.S. Cl. 29/407.1; 29/468

(57) ABSTRACT

A method for the automated mounting of a plurality of add-on parts (3, 3′) on a work piece (1), in particular on a vehicle body, wherein the add-on parts (3, 3′) are to be attached to the work piece (1) in such a way that they are oriented with respect to one another in a precisely positioned fashion. Each add-on part (3, 3′) is held here in a mounting tool (5, 5′) which is guided by means of a robot (7, 7′). A sensor system (18, 18′) which is fixedly connected to the mounting tool (5, 5′) and has at least one sensor (19, 19′) is attached to at least one of the mounting tools (5, 5′). The mounting tools (5, 5′) are moved, using an iterative closed-loop control process (A-2′) using measured values of the sensors (19, 19′), into a preliminary position (23, 23′) in which the add-on parts (3, 3′) which are held in the mounting tools (5, 5′) are oriented with respect to one another in a precisely positioned fashion. The mounting tools (5, 5′) with the add-on parts (3, 3′) which are held therein and are oriented with respect to one another in a precisely positioned fashion are then moved from the preliminary position (23, 23′) into a mounting position (27, 27′) with respect to the work piece (1), in which position they are connected to the work piece (1).

The invention relates to a method for mounting a plurality of add-on parts on a work piece, in particular on a vehicle body, wherein the add-on parts are attached to the work piece in such a way that they are oriented with respect to one another in a precisely positioned fashion. Furthermore, the invention relates to a mounting system for carrying out this method.

Add-on parts (for example doors, rear module, front module, etc) are attached or installed at different locations in the outer area and in the inner area in the course of the mounting operations. In the interests of a high quality appearance of the vehicle it is necessary to orient these add-on parts with high precision with respect to adjacent areas on the vehicle body or with respect to other (adjacent) add-on parts and installed parts and thus to position them in such a way that a predefined junction between the add-on part and the adjacent vehicle body areas is ensured. For this purpose, the add-on part must be oriented in a precisely positioned fashion with respect to the vehicle body and be attached in this state to the vehicle body using a joining method, for example by screwing on. Such a method for high precision orientation of an add-on part with respect to a work piece is described, for example, in (PCT Application, our file number P803949/WO/1).

In many application cases, within the scope of the mounting operations a plurality of add-on parts (different and usually adjacent parts) are attached to a work piece, which parts have to be oriented as precisely as possible not only with respect to the adjacent vehicle body areas but also in relation to one another. An example of this is the mounting of side doors on vehicle bodies: the driver's door directly adjoins the rear door in the vicinity of the B pillar. In order to achieve a high quality appearance of the finished vehicle, the positions of these two doors must be matched to one another in a highly precise way. In particular, a gap which is formed between the driver's door and rear door must be as uniform as possible and furthermore the depth dimensions of the two doors in this area must correspond as precisely as possible. For this reason, there is much interest in a large-scale series production method which can be automated and which can be used to insert these two doors into the associated door openings and attach them in such a way that high precision relative orientation of the two doors is provided by controlled processing.

The invention is thus based on the object of proposing a method which can be automated and which can be used to attach a plurality of add-on parts, in particular two adjacent vehicle doors, to a work piece, in particular to a vehicle body, in such a way that they are precisely positioned with respect to one another. The invention is also based on the object of proposing a device which is suitable for carrying out the method.

The object is achieved according to the invention by means of the features of claims 1 and 6.

Accordingly, the add-on parts which are to be mounted with respect to one another in a precisely positioned fashion are attached to the work piece in a common mounting process. The add-on parts are positioned and attached using robot-guided mounting tools, a separate robot-guided mounting tool being provided for each of the add-on parts involved. Using these mounting tools, the add-on parts which are to be installed together are firstly oriented with respect to one another in a precisely positioned fashion in a preliminary position and then, while retaining this precisely positioned orientation, are positioned on the work piece and connected to it. In order to orient the add-on parts in the preliminary position, an iterative closed-loop control process is used, by means of which process the second add-on part (and possibly the other add-on parts) is/are moved and/or pivoted with respect to the first add-on part which is held in a spatially fixed fashion, until the desired relative position of the add-on parts is reached. The iterative closed-loop control process uses measured values of a sensor system which is permanently connected to one of the mounting tools and supplies measured values of selected measured variables to the add-on parts which are of particular significance for the assessment of the relative position. If, for example, two add-on parts which are to be installed adjacent to one another in the work piece are oriented with respect to one another by their adjoining edges, the gap dimensions along these edges play a significantly important role as measured variables.

The iterative closed-loop control process by means of which the add-on parts are oriented with respect to one another in a precisely positioned fashion advantageously comprises the following process steps:
(actual) measured values of the measured variables are generated,
these (actual) measured variables are compared with (setpoint) measured values which have been generated within the scope of what is referred to as a “set up phase” (which precedes the actual working phase),
a movement vector of the mounting tools is calculated from the difference between (actual) measured values and (setpoint) measured values using what is referred to as a “Jacobi matrix” (or “sensitivity matrix”) calculated within the scope of the set up phase, and
the mounting tools are moved with respect to one another by an amount equal to this movement vector.
   This control loop is run through until
either the deviation between (setpoint) measured values and (actual) measured values lies below predefined threshold values, or
the reduction in these deviations which can be brought about during successive iteration steps lies below a predefined threshold.

Both the (setpoint) values and the Jacobi matrix are determined within the scope of a set up phase, which precedes the actual positioning and mounting process, in the scope of which phase the mounting tools are trained to the specific mounting task. This set up phase is run through once in the course of the setting of a new combination of tools, sensor system, work piece and type and installation position of the add-on parts to be used.

The method has the large advantage that it is independent of the precise spatial position of the work piece and of the add-on parts. In particular, the positioning process which is to be run through in a controlled fashion, and in the scope of which the add-on parts which are held in the mounting tools are oriented with respect to one another in a precisely positioned fashion, does not require any information about the absolute positions of the individual add-on parts in the working space of the robots which are involved; the method according to the invention is based exclusively on relative measurements in the scope of which information (stored in the set up phase) which corresponds to a set of (setpoint) measured values of the sensor system is restored by means of the closed-loop control process. This is associated with large processing and equipment advantages;
on the one hand, internal metric calibration of the sensors is not necessary since the sensors which are used no longer “measure” but merely react to a monotonous incremental movement of the robot with a monotonous change in their sensor signal. This means, for example, that when a television or CCD camera is used as a sensor the lens distortions within the camera do not need to be compensated and that when a triangulation sensor is used the precise metric calculation of distance values is dispensed with.
furthermore, external metric calibration of the sensors is not necessary. This means that the position of the sensors does not need to be determined metrically with respect to the working space of the robot which is fitted with the sensor or the coordinate system of the associated robot's hand in order to be able to calculate suitable correction movements. The sensors merely have to be attached to the mounting tool in such a way that they are at all capable of sensing, in their capture range, suitable measured data of the reference areas on the add-on parts which are involved in the orientation process.

It is thus possible to completely dispense with a calibration process for determining the internal and external calibration of the sensors. Metrically noncalibrated sensors, which are significantly simpler and thus also cheaper than calibrated sensors, can therefore be used. Both the design of the instrumentation and the installation and operation of the entire system can therefore be implemented in a very cost-effective way. Furthermore, the initial installation and maintenance of the mounting system is drastically simplified and can also be performed by trained personnel.

The result of the relative positioning of the add-on parts with respect to one another is also independent of the absolute positioning accuracy of the robots used since possible robot inaccuracies during the iterative closed-loop control process which is run through in order to move to the preliminary position are compensated. A very high repetition accuracy in the positioning result can be achieved when necessary owing to the resulting short fault chains.

The number of degrees of positioning freedom which can be compensated using this method for the relative positioning of the add-on parts is freely selectable and depends only on the configuration of the sensor system. The number of sensors used can also be freely selected. The number of (scalar) sensor information items made available merely has to be equal to or larger than the number of degrees of freedom to be closed-loop controlled. In particular, a relatively large number of sensors can be provided and the redundant sensor information can be used in order, for example, to sense better shaping errors in the reference areas under consideration on the add-on parts or to improve the accuracy of the positioning process. Finally, sensor information can be used from different contact-free and/or tactile sources (for example a combination of CCD cameras, optical gap sensors and tactile distance measuring sensors). As a result, by using suitable sensors it is possible to take into account with respect to one another the measurement results of different quality-related variables (gap dimensions, junction dimensions, depth dimensions) during the orientation process for the add-on parts.

The method permits rapid compensation of residual uncertainties which may occur when positioning add-on parts with respect to one another; such residual uncertainties may come about as a result of deviations in position of the add-on parts which are to be oriented with respect to one another, in the respective mounting tools and/or as a result of shaping errors of the add-on parts which are caused by component tolerances.

When the positioning process, in the scope of which the add-on parts are moved into a desired relative position with respect to one another, has been completed, the add-on parts which are oriented with respect to one another in this way are conveyed to the work piece and connected to it. In order to avoid losing the highly precise relative orientation of the two add-on parts (which is achieved in the preliminary position), the two robots which carry the add-on parts are advantageously coupled to one another in the preliminary position; one of the two robots serves here as a “master” robot whose movements are followed by the other, so-called “slave” robot. When the add-on parts are moved toward the work piece, the “master” robot therefore takes the “slave” robot along with it on its setpoint path so that the spatial relationship between the add-on parts remains unchanged. An open-loop control principle which can be used to bring about such coupling is known, for example, from EP 752 633 A1, the contents of which are transferred herewith into the present application.

In order, in addition to the high precision orientation of the add-on parts in relation to one another, to bring about a high level of accuracy when positioning and mounting the add-on parts in the work piece, it is advantageous also to fit in the add-on parts (coupled to one another by means of the mounting robots) to the work piece within the scope of an iterative closed-loop control process. In this case, a further sensor system is provided which is permanently connected to one of the mounting tools and comprises sensors which, when the coupled add-on parts are moved toward the work piece, are directed at selected reference areas on the work piece. The measured values which are supplied by the sensors are used to bring about iterative orientation of the add-on parts with respect to the work piece, in a way which is analogous to the iterative orientation of the add-on parts with respect to one another which is described above.

Further advantageous embodiments of the invention can be found in the subclaims. The invention will be explained in more detail below with reference to an exemplary embodiment which is illustrated in the drawings, in which:

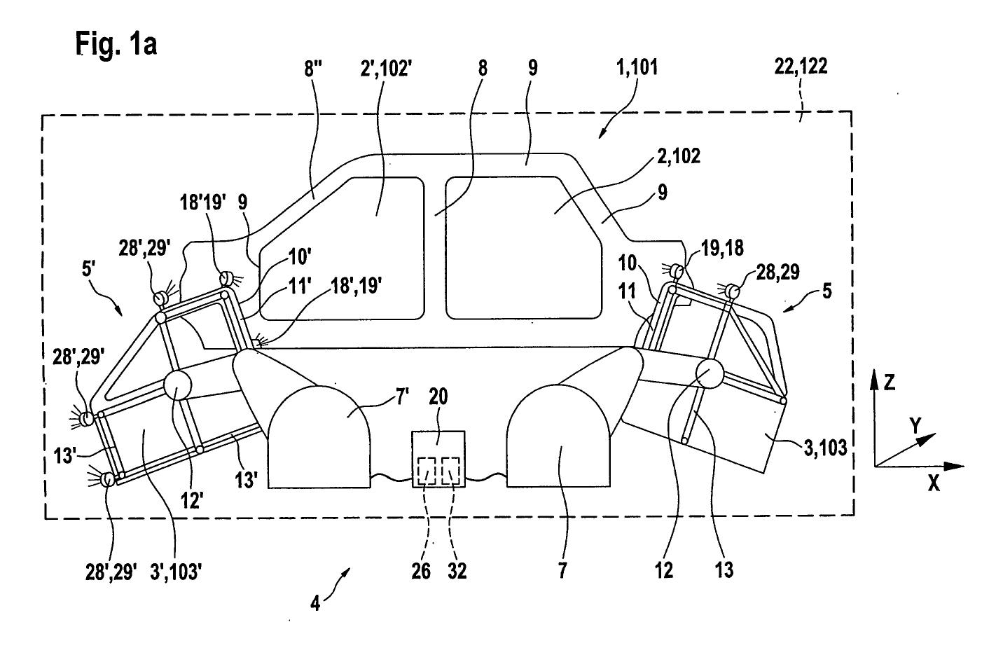

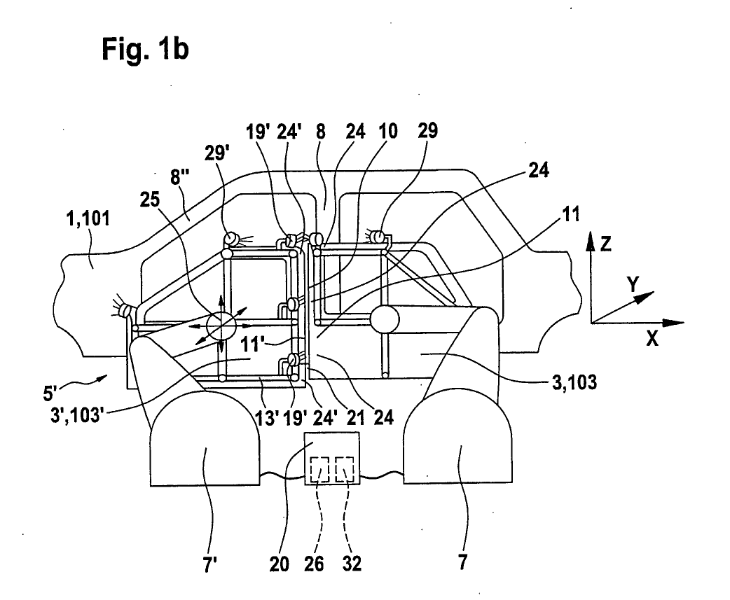

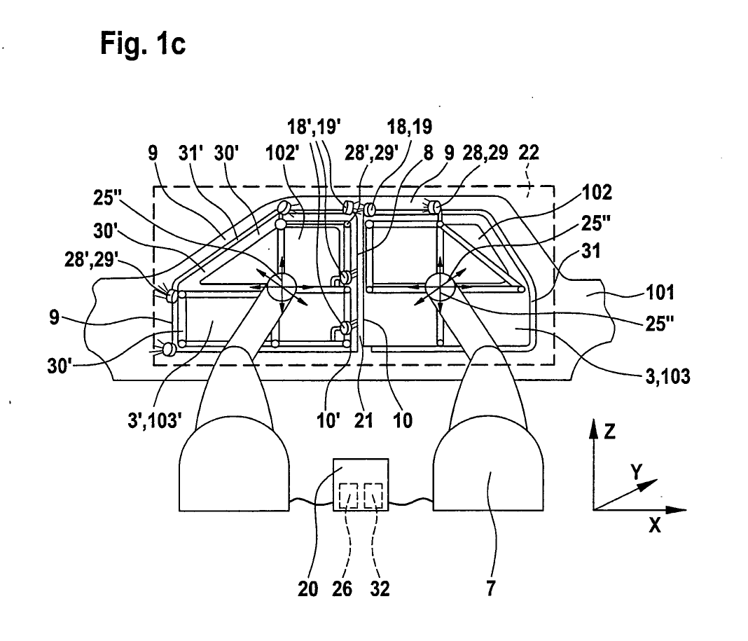

FIG. 1 is a schematic illustration of selected positions of a mounting system during the precisely positioned orientation and mounting of two doors in a vehicle body

FIG. 1a: Return movement position;

FIG. 1b: Preliminary position;

FIG. 1c: Mounting position,

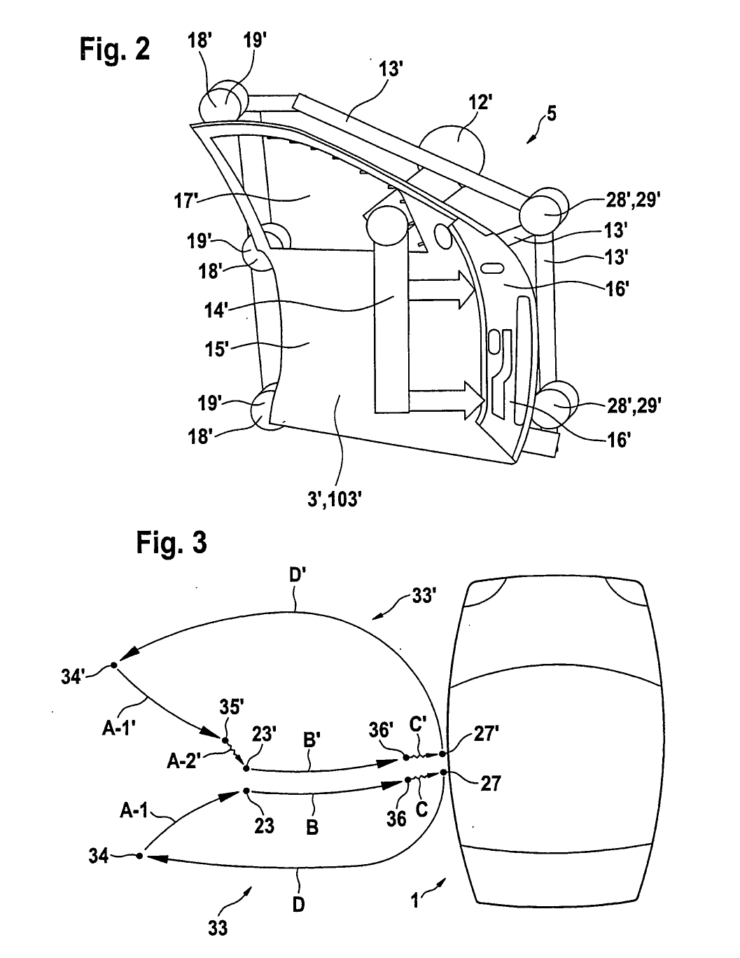

FIG. 2 is a schematic detailed view of a driver's door mounting tool, and

FIG. 3 is a schematic illustration of the movement paths of the robot's hands which carry the driver's door mounting tool and the rear door mounting tool.

FIG. 1 shows a detail of a vehicle body 1 with a rear door opening 2 in which a rear door 3 is to be mounted, in the course of the mounting of the vehicle, and a front door opening 2′ in which a driver's door 3′ is to be mounted. This vehicle body 1 is an example of a work piece with adjacent openings 2, 2′ into which adjacent add-on parts 2, 2′ whose shape is adapted to that of the openings 2, 2′ are to be inserted in a precisely positioned fashion: in the installation position of the doors 3, 3′ the rear door 3 directly adjoins, with its edge 10 which is at the front in the direction of travel, the edge 10′, at the rear in the direction of travel, of the driver's door 3′ (see FIGS. 1b and 1c) in the vicinity of the B pillar 8 of the vehicle body 1.

The mounting of the two doors 3, 3′ in the vehicle body 1 is carried out using an automatic mounting system 4 (illustrated schematically in FIG. 1) with a working space 6. The mounting system 4 comprises a mounting tool 5 which is guided by an industrial robot 7 and which feeds in the rear door 3 and positions it in the door opening 2 in the vehicle body 1. Furthermore, the mounting system 4 comprises a mounting system 5′ which is guided by an industrial robot 7′ and which feeds in the driver's door 3′ and positions it in the door opening 2′ in the vehicle body 1. An open-loop open-loop control system 20 is provided for performing open-loop control of the position and movement of the robot 7, 7′ and of the tools 5, 5′. By analogy to the mounting system 4 in FIG. 1 for mounting the left-hand rear door 3 and driver's door 3′, a further mounting system for the right-hand rear door, whose design and method of operation corresponds to that of the mounting system 4 (mirror inverted) is provided (on the opposite side of the vehicle body 1).

In order to ensure a high quality visual appearance of the vehicle body 1, the doors 3, 3′ must be mounted in a precisely positioned fashion (with respect to position and angular attitude) with respect to the areas 9 of the vehicle body 1 which are adjacent to the door openings 2, 2′; these surrounding areas 9 thus form what is referred to as a reference area for orienting the doors 3, 3′ with respect to one another with respect to the vehicle body 1. Furthermore it is important to orient the two doors 3 and 3′ with high precision in such a way that in the vicinity of their adjacent edges 10, 10′ they assume a predefined relative position, in particular form an equal gap 21 and a match to one another with respect to their length in the Z (vertical) and Y (transverse) direction of the vehicle body. The areas 11, 11′ which are adjacent to the edges 10, 10′ on the doors 3, 3′ thus form what are referred to as the reference areas for orienting the doors 3, 3′ with respect to one another.

The robot-guided mounting tool 5′ which is used to position the driver's door 3′ in the door opening 2′ and the subsequent mounting is shown schematically in FIG. 2. This mounting tool 5′ which is attached to the hand 12′ of the industrial robot 7′ comprises a frame 13′ to which a securing device 14′ is, by means of which the driver's door 3′ can be held in a well defined position, is attached. The door 3′ is held by the securing device 14′ on the inside 15′ of the door 3′ in the direct vicinity of hinge holding faces 16′ to which attachment hinges are screwed in the course of the mounting of the door (not illustrated in FIG. 2). This selection of the engagement points of the securing device 14′ on the driver's door 3′ ensures that there is a minimal lever arm between the connecting points (defined by the hinges) of the driver's door 3′ in the vehicle body 1 and the engagement points of the securing device 14′, with the result that the effect of the force of gravity on the door 3′ held in the securing device 14′ is approximately identical to that on the completely installed door 3′. This ensures that the distortion of the shape which occurs during the installation of the door is minimal. The securing device 14′ is designed in such as way that the area of the hinge holding faces 16′ on the inside 15′ of the door is freely accessible so that the hinges can be mounted while the door 3′ is in the securing device 14′. The design of the securing device 14′ shown in FIG. 2 also ensures that the door 3′ can be positioned by means of the mounting tool 5′ in the installation position (i.e. in the closed state) on the vehicle body 1′. The securing device 14′ is arranged so as to be capable of rotating and/or pivoting with respect to the frame 13′ of the mounting tool 5′ so that it can be removed after the mounting through the window opening 17′ of the mounted and closed door 3′. The mounting tool 5 for the rear door 3 is of analogous design.

So that the driver's door 3′ which is secured in the mounting tool 5′ can be oriented in a precisely positioned fashion with respect to the rear door 3 which is held in the mounting tool 5, the mounting tool 5′ is provided with a sensor system 18′ with a plurality of sensors 19′ (three in the schematic illustration in FIG. 2) which are rigidly connected to the frame 13 of the mounting tool 5′; they thus form one structural unit with the mounting tool 5′. These sensors 19′ serve to determine joint dimensions, gap dimensions and depth dimensions between the front edge 10 of the rear door 3 and the rear edge 10′ of the driver's door 3′. The driver's door 3′ which is held in the mounting tool 5′ is oriented, as described below, with respect to the rear door 3 in an iterative closed-loop control process using the sensor system 18′.

If the mounting system 4 is to be set to a new processing task, for example to the mounting of the doors in a new type of vehicle, what is referred to as a set up phase must firstly be run through, in which phase the mounting tools 5, 5′ are configured. In this context, as with the driver's door 3′ which was to be mounted, an adapted securing device 14′, a suitably designed frame 13′ and a sensor system 18′ with the corresponding sensors 19′ are selected and configured together to form the mounting tool 5′. Furthermore, a mounting device 5 for the rear door 3 is configured from a securing device 14 and a frame 13. After this, the sensor system 18′ of the mounting tool 5′ is “trained” by, as described below in section I, (setpoint) measured values of the sensor system 18′ being recorded on a “master” rear door 103 and a “master” driver's door 103′. Furthermore, in a second training phase, as described in section II below, the two “master” doors 103, 103′ which are oriented with respect to one another are trained to a “master” vehicle body 101 and the path sections of the movement paths of the robots 7, 7′ which are to be run through in an open-loop controlled set up fashion are programmed. After these phases I, II have ended, the mounting system 4 which is configured and calibrated in this way is ready for series use during which what is referred to as a working phase is run through for each vehicle body 1 which is fed to the working space 6 of the robots 7, 7′, during which phase, as described below in section III, two associated doors 3, 3′ are firstly oriented with respect to one another in a precisely positioned fashion and then conveyed together into the door opening 2, positioned there and attached there.

I. Set Up Phase of the Mounting Tool 5′ With Respect To the Adjacent Add-On Part (i.e. With Respect To the Rear Door 103)

In order to carry out a newly set mounting task, in a first step the rear door mounting tool 5 which is configured as described above is firstly attached to the robot's hand 12 and equipped with a (“master”) rear door 103. The mounting tool 5 is then moved, using the robot 7, into a freely selectable so-called rear door preliminary position 23 which is located outside the actual mounting area 122 on the vehicle body 101; in this position the mounting tool 5 is held in a fixed fashion during the set up phase.

Furthermore, a sensor system 18′ which is adapted to the mounting task is selected and configured together with the securing device 14′ to form the mounting tool 5′, which is itself attached to the robot's hand 12′. The securing device 14′ is equipped with a (“master”) driver's door 103′ and oriented (manually or interactively) with respect to the (“master”) rear door 103 in the rear door preliminary position 23 in such a way that an “optimum” orientation of the two doors 103, 103′ with respect to one another is provided (see FIG. 1b). This “optimum” orientation is defined in the present case in that the gap 21 between the two doors 103, 103′ is as uniform as possible, in that there is no depth offset between the two edges 10, 10′ in the transverse direction (Y direction) of the vehicle, in and that the reference areas (11, 11′) of the two doors (103, 103′) are aligned with one another in the Z direction. The relative position which is assumed by the mounting tool 5′ with respect to the mounting tool 5 here is referred to below as driver's door preliminary position 23′.

The number and position of the sensors 19′ on the frame 13′ of the mounting tool 5′ is selected such that the sensors 19′ are directed toward suitable areas 24′, which are particularly important for the “optimum” orientation, on the (“master”) driver's door 103′ or areas 24 of the (“master”) rear door 103. In the exemplary embodiment in FIGS. 2, 1b, three sensors 19′ are used which are directed toward the areas 24, 24′ which are shown in FIG. 1 so that the sensors 19′ carry out gap measurements in the upper, center and lower regions of the opposite edges 10, 10′ of the two (“master”) doors 103, 103′. The number of individual sensors 19′ and the surroundings 24, 24′ toward which they are oriented are selected in such as way that they permit the best possible characterization of the quality features which are relevant for the respective application case. In addition to the gap measurement sensors 19′, it is also possible to provide other sensors which measure, for example, a (depth) distance between the two (“master”) doors 103, 103′.

The mounting tool 5′ with the sensor system 18′ and with the (“master”) driver's door 103′ held in the securing device 14′ is now “trained”, using the robot 7′, to the driver's door preliminary position 23 (which has been set by means of the manual or interactive orientation and assumed in the illustration in FIG. 1b). In this case, measured values of all the sensors 19′ are firstly recorded in the driver's door preliminary position 23′ and stored as “setpoint measured values” in an evaluation unit 26 of the sensor system 18′; this sensor evaluation unit 26 is expediently integrated into the open-loop control system 20 of the robots 7, 7′. Then, using the robot 7′, the position of the mounting tool 5′ and of the (“master”) driver's door 103′, held therein, with respect to the (“master”) rear door 103 is changed systematically along known movement paths, as shown by arrows 25 in FIG. 1b, starting from the driver's door preliminary position 23′; these are generally incremental movements of the robot 7′ in its degrees of freedom. The changes which occur in the measured values of the sensors 19′ in this process are recorded (completely or partially). What is referred to as a Jacobi matrix (sensitivity matrix) is calculated from this sensor information in a known fashion, said matrix describing the relationship between the incremental movements of the robot 7′ and the changes which occur in the sensor measured values in the process. The method for determining the Jacobi matrix is described, for example, in “A tutorial on visual servo control” by S. Hutchinson, G. Hager and P. Corke, IEEE Transactions on Robotics and Automation 12 (5), October 1996, pages 651-670. In this article, the requirements made of the movement paths and of the measuring environments are also described (constancy, monotony, etc) which have to be fulfilled in order to obtain a valid Jacobi matrix. The incremental movements are selected in such a way that during this set up process there can be no collisions between the mounting tool 5′ or the (“master”) driver's door 103′ and the (“master”) rear door 103 which is held in a fixed fashion.

The Jacobi matrix which is generated in the set up phase is stored, together with the “setpoint measured values” in the evaluation unit 26 of the sensor system 18′ and forms the basis for the later positioning closed-loop control process A-2′ in the working phase (see section III below).

II. Set Up Phase of the Mounting Tool 5′ With Respect To the Work Piece (i.e. With Respect To the Vehicle Body 1)

In a subsequent step, the two mounting tools 5, 5′ are moved (manually or interactively) using the robots 7, 7′ to a (“master”) vehicle body 101 which is located in the working space 6 of the mounting system 4. In this context, the relative position of the two (“master”) doors 103, 103′ corresponding to the preliminary position 23, 23′ (i.e. the desired relative orientation of the two doors 103, 103′ which is set manually in the process step I) is retained.

By analogy with the above-described training of the preliminary position 23′ of the mounting tool 5′ with respect to the mounting tool 5 (held in a fixed fashion in the preliminary position 23), the coupled System of the two mounting tools 5, 5′ is then trained with respect to the (“master”) vehicle body 101. For this purpose, the two doors 103, 103′ which are held in the mounting tools 5, 5′ (oriented with respect to one another) are positioned (manually or interactively) using the robots 7, 7′ in the desired (“optimum”) position and orientation in the door opening 102, 102′ in the (“master”) vehicle body 101. The relative position assumed here by the pair of doors 103, 103′ with respect to the (“master”) vehicle body 101 is referred to below as “mounting position” 27 and corresponds to that relative orientation of the pair of doors 103, 103′ with respect to the vehicle body 101 in which the two doors are to be attached in the vehicle body 101.

In order to train the mounting position 27, a further sensor system 28′ (with sensors 29′) is used, which sensor system 28′ is also permanently connected to the mounting system 5′. In this context, some (or all) of the sensors 18′ of the sensor system 19′ can also be used as sensors 29′ of the sensor system 28′. The sensors 29′ are attached to the mounting tool 5′ in such a way that they are directed toward the selected reference areas 9 on the (“master”) vehicle body 101 and/or to selected reference areas 30′ of the (“master”) driver's door 103′. In the present exemplary embodiment, the sensor system 28′ comprises four sensors 29′, two of which are directed toward a vehicle body area 9 in the vicinity of the A pillar 8″ and a further sensor 19′, which has already been used for relative orientation of the two doors 103, 103′ in the course of phase I, is directed toward the upper areas of the B pillar 8. The sensors 29′ are advantageously (optical) gap sensors which measure the width of the gap 31′ between the driver's door 103′ and the vehicle body 101 in the respective detection range.

The mounting tools 5, 5′ which are coupled to one another by robot technology and which have the sensor system 28′ are then “trained”, using the robots 7, 7′ which are moved in a coupled fashion, to the mounting position 27, 27′ (set manually or interactively) of the (“master”) pair of doors 103, 103′ with respect to the (“master”) vehicle body 101. This iterative training is carried out in a way analogous to the training process, described in section I, of the mounting tool 5′ in which the mounting tool 5′ has been trained with the (“master”) driver's door 103′ to the (driver's door) preliminary position 23′ with respect to the (“master”) rear door 103 which is held in a fixed fashion: firstly, while the two mounting tools 5, 5′ are in the mounting position 27, 27′, measured values of the reference areas 9, 30′ are recorded on the (“master”) vehicle body 101 and/or the (“master”) driver's door 103′ using the sensor system 28 and stored as “setpoint measured values” in an evaluation unit 32 which is associated with the sensor system 28 and is integrated in the open-loop control system 20 of the robot 7, 7′. Then, starting from this mounting position 27, 27′, the position of the (“master”) doors 103, 103′ which are oriented with respect to one another is systematically changed with respect to the (“master”) vehicle body 101 along known movement paths (arrows 25″) using the coupled robots 7, 7′ in synchronism with one another. The Jacobi matrix (sensitivity matrix) of the coupled mounting tools 5, 5′ is calculated from the associated changes in the measured values of the sensors 29′, said Jacobi matrix describing the relationship between the incremental movements of the coupled robots 7, 7′ and the changes which occur in the measured values of the sensors 29′ in the process. The incremental movements are selected in such a way that there can be no collisions between the doors 103, 103′ or the tools 5, 5′ and the (“master”) vehicle body 101 during this set up process. The Jacobi matrix which is generated is stored, together with the “setpoint measured values” in the evaluation unit 32 of the sensor system 28′ and forms the basis for the later closed-loop control process in the positioning phase C, C′ of the coupled tools 5, 5′ with respect to the vehicle body 1 (see III below).

In addition to training the mounting position 27, 27′, in this set up phase movement paths 33, 33′ of the robots 7, 7′ are generated (illustrated schematically in FIG. 3). The starting point of the movement paths 33, 33′ of the two robots 7, 7′ is formed in each case by what is referred to as a “return movement position” 34, 34′ which is selected in such a way that a new vehicle body 1 can be introduced into the working space 6 of the robots 7, 7′ without collisions being able to occur between the vehicle body 1 and the mounting tools 5, 5′. These return movement positions 34, 34′ may correspond, for example, to different equipping stations (not illustrated in the figures) in which the mounting tools 5, 5′ are equipped (manually) with the doors 3, 3′ to be installed. Alternatively, the return movement positions 34, 34′ can correspond to removal stations in which the mounting tools 5, 5′ remove (automatically) the doors 3, 3′ to be installed from work piece carriers.

Starting from this return movement position 34, 34′, the movement paths 33, 33′ of the two mounting tools 5, 5′ comprise the following separate sections:

A-1 The rear door mounting tool 5 with inserted rear door 3 is moved from the return movement position 34 into the rear door preliminary position 23 on a path A-1 which is to be run through in an open-loop controlled fashion.

A-1′ At the same time or after this, the driver's door mounting tool 5′ with inserted driver's door 3′ is moved on a path A-1′ to be run through in an open-loop controlled fashion, from the return movement position 34′ into what is referred to as an “orientation position” 35′ which is selected in such a way that all the individual sensors 19′ of the sensor system 18′ can sense valid measured values of the respective areas 22, 24′ of the rear door 3′ and/or of the driver's door 3, while at the same time it is ensured that no collisions can take place between the mounting tools 5, 5′ or the doors 3, 3′ held in them.

A-2′ The driver's door mounting tool 5′ with inserted driver's door 3′ is moved on a path A-2′ to be run through in a closed-loop controlled fashion, from the orientation position 35′ into the driver's door preliminary position 23′ (“trained” as described above) in which the driver's door 3′, which is held in the mounting tool 5′, is oriented in a precisely positioned and angled fashion with respect to the rear door 3 which is held in the mounting tool 5. What happens in particular during this process step to be run through in a closed-loop controlled fashion is described below (in III. working phase).

B, B′ The rear door robot 7 is then coupled to the driver's door robot 7′ and the two robots 7, 7′ are moved on a path B or B′ to be run through in an open-loop controlled fashion, from the preliminary position 23, 23′ into a proximity position 36, 36′ with respect to the vehicle body 1. The proximity position is selected such that all the individual sensors 29′ of the sensor system 28′ supply valid measured values of the reference areas 9, 30, 30′ (relevant for the fitting of the door) on the vehicle body 1 and the doors 3, 3′, while at the same time it is ensured that collisions cannot occur between the mounting tools 5, 5′ or the doors 3, 3′ held therein and the vehicle body 1.

C, C′ The mounting tools 5, 5′ are moved by the coupled robots 7, 7′ on a path C or C′ to be run through in a closed-loop controlled fashion from the proximity position 36, 36′ into the mounting position 27, 27′ (‘trained’ as described above) in which the two doors 3, 3′ are oriented precisely in terms of angle and distance with respect to the door openings 2, 2′ in the vehicle body 1 (without loss of the highly precise relative orientation of the doors 3, 3′ which is brought about in process step A-2′). The two doors 3, 3′ are then mounted in their mounting position 27, 27′ on the door openings 2, 2′ of the vehicle body 1.

D, D′ The securing devices 14, 14′ of the mounting tools 5, 5′ are detached, as a result of which the doors 3, 3′ are released. The coupling of the two robots 7, 7′ is then disconnected and both mounting tools 5, 5′ are moved back (independently of one another) under the control of a robot into their respective return movement positions 34, 34′.

The movement paths 46, 46′, generated within the scope of this set-up phase, of the two mounting tools 5, 5′ (or of the associated robot 7, 7′) is thus composed of the sections A-1, A-1′, B/B′ and D/D′ which are to be run through in an open-loop controlled fashion as well as the sections A-2′ and C/C′ which are to be run through in a closed-loop controlled fashion.

III Working Phase

In the working phase, vehicle bodies 1 are fed in sequentially to the working space 6 of the mounting system 4 and clamped into position, and the movement paths 33, 33′ of the robots 7, 7′ or of the mounting tools 5, 5′, which are generated in the set-up phase II are run through.

Movement Path Sections A-1 And A-1′

While the new vehicle body 1 is being fed in, the two mounting tools 5, 5′ are in the return movement positions 34, 34′ and are equipped with the rear door 3 to be mounted and the driver's door 3′ to be mounted (see FIG. 1a). Starting from the return movement position 34, 34′, the rear door mounting tool 5 with inserted rear door 3 is moved into the rear door preliminary position 23 while the driver's door mounting tool 5′ with inserted driver's door 3′ is conveyed into the orientation position 35′.

Movement Path Section A-2′ (Orientation Phase of the Driver's Door Mounting Tool 5′)

Starting from the orientation position 35′, a positioning phase of the mounting tool 5′ (path section A-2′ in FIG. 3) is run through, in the scope of which the driver's door 3′ which is held in the mounting tool 5′ is moved into the preliminary position 23′ (trained during the training phase) with respect to the rear door 3 which is held in a fixed fashion in the preliminary position 23, and at the same time is oriented in a precisely positioned fashion with respect to the rear door 3. For this purpose, the sensors 19′ of the sensor system 18′ record measured values in selected areas 11, 11′ of the rear door 3 and of the driver's door 3′. Using these measured values and the Jacobi matrix determined in the set up phase, a movement increment (movement vector) is calculated and said movement increment reduces the difference between the current (actual) sensor measured values and the (setpoint) sensor measured values. The driver's door 3′ which is held in the mounting tool 5′ is then moved and/or pivoted by an amount equal to this movement increment using the robot 7′, and new (actual) measured values are recorded during the ongoing movement.

This iterative measurement and movement process is repeated in a control loop until the difference between the current (actual) and the aimed-at (setpoint) sensor measured values drops below a predefined fault measure or until this difference no longer changes beyond a threshold value which is specified in advance. The driver's door 3′ is then in the preliminary position 23′ (illustrated in FIG. 1b) with respect to the rear door 3 (within the scope of the accuracy predefined by the fault measurement or threshold value).

The iterative minimization which is run through in this positioning phase A-2′ compensates both inaccuracies of the two doors 3, 3′ with respect to their position and orientation in the securing devices 14, 14′ of the mounting tools 5, 5′ and possible present shaping errors of these doors 3, 3′ (i.e. deviations from the (“master”) doors 103, 103′). The driver's door 3′ is therefore oriented in the ‘optimum’ fashion with respect to the rear door 3 within the course of this iterative closed-loop control process, independently of shaping inaccuracies and position inaccuracies. In order to detect and evaluate shaping errors on the rear door 3 and driver's door 3′ separately, it is possible to provide additional sensors on the mounting tool 5′, the measured values of which are used exclusively or partially for sensing the shaping errors. Furthermore, the measured values of the individual sensors 19′ may be provided with different weighting factors in order to optimize the position of the driver's door 3′ with respect to the rear door 3 in a weighted fashion.

One important property of this positioning phase A-2′ is its independence from the accuracy levels of the robot 7, 7′: Since the positioning process is based on an iterative comparison of the (actual) measured values with (setpoint) measured values, any positioning inaccuracy of the robots 7, 7′ is compensated immediately by the iterative closed-loop control process.

Movement Path Sections B, B′ (Movement of the Mounting Tools 5, 5′ Towards the Vehicle Body 1)

When the driver's door 3′ is oriented with respect to the rear door 3, the relative orientation which is brought about between the two robots 7, 7′ is stored as a fixed reference variable in the open-loop control system 20. The two robots 7, 7′ are then coupled to one another computationally and moved simultaneously with one another during the following method steps. In order to bring this about, the open-loop control system 20 of the robots 7, 7′ contains a controller with three subsystems:
The first subsystem contains all those instructions which describe the functions of the driver's door robot 7′ with its mounting system 5′ (inter alia the open-loop control of the paths A-1′, B′, D′ and the gripping tasks of the securing device 14 as well as the closed-loop control of the paths A-2′, C′); it also contains all the instructions for the rear door robot 7 with its mounting system 5 which are independent of the functions of the driver's door robot 7′ (that is to say inter alia the open-loop control of the paths A-1, D and the gripping tasks for the securing device 14′).
The second subsystem contains those instructions which describe functions of the robots 7, 7′ which are open-loop controlled by the first subsystem and with which the driver's door robot 7′ interacts with the rear door robot 7; this relates in particular to the path sections B/B′ and C/C′ which are to be run through in a coupled fashion.
The third subsystem contains only instructions for starting the first and second subsystems and carries out these instructions asynchronously and simultaneously.

With respect to details of the interaction between these subsystems reference is made to EP 752 633 A1. With respect to the path sections B/B′ and C/C′ in which the robot 7 is coupled to the robot 7′, the robot 7′ is referred to as the “master” and the robot 7 as the “slave”.

At the start of the movement path section B/B′, an instruction which starts the second subsystem and thus couples the “slave” robot 7 to the “master” robot 7′ is issued by the third subsystem. The driver's door robot 7′ is then moved, open-loop controlled as the “master” from the preliminary position 23′ into the proximity position 36′ in the vicinity of the driver's door opening 2′ in the vehicle body 1. During this movement, the rear door robot 7 follows said driver's door robot 7′ as the “slave” into the proximity position 36, with the highly precise relative orientation of the two doors 3, 3′ which is brought about in path section A-2′ being retained.

Movement Path Sections C, C′ (Orientation of the Mounting Tools 5, 5′ At the Door Opening 2, 2′ of the Vehicle Body 1)

Starting from the proximity position 36′, the mounting tool 5′ is then moved into the mounting position 27′ (trained during the training phase) with respect to the door opening 2′ in the vehicle body 1. This positioning phase extends in an analogous way to the positioning phase of the section A-2′, in the course of which the mounting tool 5′ was positioned with respect to the rear door 3: the sensors 29′ of the sensor system 28′ are used to record measured values on the reference faces 9 of the vehicle body 1 and/or on the reference areas 30, 30′ of the doors 3, 3′, and a movement increment is calculated from these measured values using the Jacobi matrix determined in the set-up phase II, in order to move the mounting tool 5′ using the robot 7′. Since the rear door robot 7 is coupled to the driver's door robot 7′, it follows these movements of the mounting tool 5′. The measurement and movement process is repeated iteratively until the difference between the current (actual) sensor measured values and the aimed-at (setpoint) sensor measured values drops below a predefined fault measure, or until this difference no longer changes beyond a threshold value which is specified in advance. The two mounting tools 5, 5′ are then in the mounting position 27, 27′ (illustrated in FIG. 1c) with respect to the vehicle body 1. In this position, the two doors 3, 3′ are attached to the door openings 2, 2′. For this purpose, it is possible to use, for example, screwdrivers (not shown in FIG. 1c) which are attached to additional robots or handling systems.

In order to facilitate the mounting of the doors 3, 3′ it may be expedient to move the doors 3, 3′ out of the mounting area 22 in the meantime in order to provide space there for hinge robots (not shown in the figures) which attach door hinges in the door openings 2, 2′. For this purpose, the driver's door 3′ is moved, using the robot 7′, into an avoidance position in which the mounting area is cleared. After the hinges have been mounted, the driver's door 3′ is moved back into the mounting position 27′. The coupled rear door robot 7 follows this movement so that the highly precise orientation of the two doors 3, 3′ is retained during these withdrawal movements. During the mounting of the hinges, the mounting position 27, 27′ which is discovered in the course of the positioning process and is arranged in a precisely positioned fashion with respect to the vehicle body can be used as a reference position for all the further tools and work steps which are involved in the mounting operation.

After the doors 3, 3′ have been mounted, the securing devices 14, 14′ of the mounting tools 5, 5′ are detached so that the doors 3, 3′ hang freely from the vehicle body 1. In this position, check measurements of the joint dimensions, gaps 31, 31′ and depth dimensions are carried out in the areas 9, 30, 30′ using the sensors 29. If, in the process, deviations from the setpoint dimensions are detected, defined information can be sent to the operator of the system for subsequent work.

Movement Path Sections D/D′ (Return Movement of the Mounting Tools 5, 5′)

If the doors 3, 3′ are attached in the correct position in the door openings 2, 2′, the “master” -“slave” coupling of the two robots 7, 7′ is disconnected. Furthermore, the securing devices 14, 14′ of the mounting tools 5, 5′ are pivoted out of the engagement positions in such a way that the mounting tools 5, 5′ can be moved back in a collision-free fashion under the control of the robots from the mounting position 27, 27′ into the return movement position 34, 34′. The vehicle body 1 is unclamped, lifted out and conveyed, and in parallel with this the mounting tools 5, 5′ are equipped with new doors 3, 3′, while a new vehicle body 1 is fed to the working space 6 of the mounting system 4.

For the purpose of data communication between the different system components (evaluation units 26, 32 of the sensor systems 18′, 28′ and the open-loop control systems of the robots 7, 7′ in the open-loop control system 20), a TCP/IP interface, which permits a high data rate, is advantageously used in the present exemplary embodiment. Such a high data rate is necessary in order to be able to perform closed-loop control of the entire system (sensor systems/robots) with the large number of individual sensors 19, 29 using the interpolation cycle of the robots 7, 7′ (typically 12 milliseconds) during the positioning phases A-2′ and C/C′ which are to be run through in a closed-loop controlled fashion. For less complex control problems, i.e. when less stringent requirements are being made of the precision and the control times are longer, the closed-loop control can also be implemented by means of a conventional serial interface.

In addition to the previously described gap sensors it is possible to use any optical sensors as sensors 19, 29′ for sensing the actual position of the doors 3, 3′ relative to one another and with respect to the reference area 9 on the vehicle body 1. It is possible, for example, to use CCD cameras which measure over an area as sensors 19, 29′, by means of which (in combination with suitable image evaluation algorithms) the spatial positions and the offset between edges and between spatial distances etc. can be generated as measured variables. Furthermore, any tactile and/or contact-free measurement systems can be used, with the selection of the suitable sensors depending greatly on the respective application case.

In the exemplary embodiment in FIGS. 1 to 3, the sensors 19′, 29′ of the sensor systems 18′, 28′ are mounted exclusively on the driver's door mounting 5′. Instead or in addition it is possible (as indicated in FIGS. 1a-1c) also to use, for measurement purposes, sensors 19, 29 which are attached to the rear door mounting tool 5, and the sensors can be distributed between the two mounting tools 5, 5′. In particular the sensor system 28′ may also comprise sensors 29 which are permanently connected to the mounting tool 5: since the two mounting tools 5, 5′ are permanently coupled to one another in the orientation phase C/C′, these sensors 29 assume a known position with respect to the mounting tool 5′ (within the accuracy achieved in the positioning phase).

In addition to the mounting of doors, the method can be transferred to the mounting of any other (adjacent) add-on parts which have to be mounted on a work piece with a highly precise positioned relative orientation. “Robot-guided” tools are to be understood in the context of the present application in a quite general way as tools which are mounted on a multi-axle manipulator, in particular a six-axle industrial robot.

1-8. (canceled)

9. A method for mounting a plurality of add-on parts on a work piece, the add-on parts being attached to the work piece so as to be oriented with respect to one another in a precisely positioned fashion, a mounted tool guided using a robot feeding and positioning each add-on part, at least one of the mounting tools including a securing device for receiving the respective add-on part, a sensor system being fixedly connected to at least one of the mounting tools and having at least one sensor, the method comprising the following steps:
moving the mounting tools using an iterative closed-loop control process using measured values of the at least one sensors into a preliminary position, the add-on parts in the preliminary position being held in the mounting tools and being oriented with respect to one another in a positioned fashion,
moving the mounting tools with the oriented add-on parts held therein from the preliminary position into a mounting position with respect to the work piece, the add-on parts being connected to the work piece in the mounting position.

10. The method as recited in claim 9 wherein the iterative closed-loop control process includes the following control loop steps:
generating actual measured values of the at least one sensor are generated,
comparing the actual measured values with setpoint measured values generated during a set up phase,
calculating a movement vector of the mounting tools from a difference between the actual measured values and the setpoint measured values using a Jacobi matrix,
moving the mounting tools by an amount equal to the movement vector.

11. The method as recited in claim 9 wherein the moving into the mounting position step includes running a second iterative closed-loop control process to orient the add-on parts with respect to a reference area on the work piece in a positioned fashion using measured values of the at least one sensor.

12. The method as recited in claim 9 wherein after the preliminary position has been reached, movements of the robots are coupled so that when the mounting position is reached the positioned orientation of the add-on parts with respect to one another is retained.

13. The method as recited in claim 9 wherein the add-on parts are a driver door and a rear door of a vehicle body, the driver door and rear door being oriented with respect to one another in a positioned fashion and being screwed securely to door openings in the vehicle body.

14. The method as recited in claim 9 wherein the work piece is a vehicle body.

15. A method for mounting a first add-on part and a second add-on part on a work piece, the first add-on part being attached to the work piece so as to be oriented with respect to the second add-on part in a precisely positioned fashion, a first mounted tool guided using a first robot feeding and positioning the first add-on part and a second mounted tool guided using a second robot and positioning the second add-on part, the first mounting tool including a securing device for receiving the first add-on part, a first sensor being fixedly connected to the first mounting tool and a second sensor being fixedly connected to the second mounting tool, the method comprising the following steps:
moving the first and second mounting tools using an iterative closed-loop control process using measured values of the first and second sensors into a preliminary position, the first and second add-on parts in the preliminary position being held in the first and second mounting tools respectively and being oriented with respect to one another in a positioned fashion,
moving the first and second mounting tools with the oriented first and second add-on parts held respectively therein from the preliminary position into a mounting position with respect to the work piece, the first and second add-on parts being connected to the work piece in the mounting position.

16. The method as recited in claim 15 wherein the iterative closed-loop control process includes the following control loop steps:
generating actual measured values of the first and second sensors are generated,
comparing the actual measured values with setpoint measured values generated during a set up phase,
calculating a movement vector of the first and second mounting tools from a difference between the actual measured values and the setpoint measured values using a Jacobi matrix,
moving the first and second mounting tools by an amount equal to the movement vector.

17. The method as recited in claim 15 wherein the moving into the mounting position step includes running a second iterative closed-loop control process to orient the first and second add-on parts with respect to a reference area on the work piece in a positioned fashion using measured values of the first and second sensors.

18. The method as recited in claim 15 wherein after the preliminary position has been reached, movements of the first and second robots are coupled so that when the mounting position is reached the positioned orientation of the first and second add-on parts with respect to one another is retained.

19. The method as recited in claim 15 wherein the first add-on part is a driver door and the second add-on part a rear door of a vehicle body, the driver door and rear door being oriented with respect to one another in a positioned fashion and being screwed securely to door openings in the vehicle body.

20. The method as recited in claim 15 wherein the work piece is a vehicle body.

21. A mounting system for simultaneously mounting a plurality of add-on parts on a work piece comprising:
a plurality of robots, each fitted with a mounting tool for receiving an add-on part;
an open-loop control system having, for each robot, a processing program for open-loop controlling a path of the robot and for open-loop controlling a movement of the mounting tool;
a sensor system including at least one sensor fixedly connected to a first of the mounting tools, the at least one sensor being directed to a reference area of an add-on part held in a second of the mounting tools; and
an evaluation unit for evaluating measured values of the sensor system.

22. The mounting system as recited in claim 21 wherein the at least one sensor is a metrically noncalibrated sensor.

23. The mounting system as recited in claim 21 further comprising a TCP/IP interface for communication between the open-loop control system and the evaluation unit.
